(19) United States
(12) Patent Application Publication
(10) Pub. No.: US 2020/0407387 A1
(43) Pub. Date: Dec. 31, 2020

(54) Process for Preparing a Transition Metal-Schiff Base Imine Ligand Complex

(71) Applicant: Reliance Industries Limited

(72) Inventors: Mahuya Bagui, Vadodara (IN); Yogesh Popatrao Patil, Maharashtra (IN); Viralkumar Patel, Nadiad (IN); Raksh Vir Jasra, Vadodara (IN); Ajit Behari Mathur, Vadodara (IN); Gopal Tembe, Vadodara (IN); Uma Sankar Satpathy, Vadodara (IN); Satya Srinivasa Gandham, Tadepalligudem (IN)

(73) Assignees: Reliance Industries Limited, Mumbai, Maharashtra (IN); Reliance Industries Limited, Mumbai, Maharashtra (IN)

(21) Appl. No.: 16/071,187

(22) PCT Filed: Jan. 25, 2017
(86) PCT No.: PCT/IB2017/050369

§ 371 Date: Jul. 19, 2018

(30) Foreign Application Priority Data
Jan. 25, 2016 (IN) 201621002773

(51) Int. Cl. C07F 15/02; C07F 7/28; C07F 13/00; C07F 7/00; C07F 11/00; C07F 9/00

(52) U.S. Cl. CPC C07F 15/025; C07F 7/28; C07F 9/005; C07F 7/003; C07F 11/005; C07F 13/005

(57) ABSTRACT

The present disclosure relates to a process for preparing a transition metal-Schiff base imine ligand complex. The process involves direct chelation of a Schiff base imine ligand by adding a transition metal halide in a halogenated fluid medium at a temperature in the range of 20° C. to 40° C. The process employs less hazardous reagents and mild reaction conditions to obtain the complex. The complex is efficient to be used as a catalyst for the production of disentangled ultra-high molecular weight polyethylene.

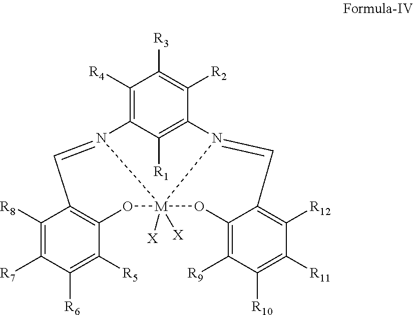

### FIELD

The present disclosure relates to a process for preparing a transition metal-Schiff base imine ligand complex.

### Definitions

As used in the present disclosure, the following term is generally intended to have the meaning as set forth below, except to the extent that the context in which they are used indicate otherwise.

Disentangled ethylene based polymer: The term ‘disentangled ethylene based polymer’ refers to homo-polymer(s) or copolymer(s) of ethylene having molar mass in the range of 0.1 million to 25 million, crystallinity greater than 75%, heat of melting greater than 180 J/g, and bulk density in the range of 0.03 g/cc to 0.2 g/cc. The disentangled ultra-high molecular weight ethylene based polymer is characterized by increase in elastic modulus, represented by a ratio of G′/G₀ (G′ is the elastic modulus at any point in the curve and G° is the initial elastic modulus) with time above the melt temperature when tested on strain controlled rheometer having parallel plate assembly as disentangled polymer chains tend to entangle on application of shearing in sinusoidal test. A representative graph of the change in elastic modulus of the disentangled ultra-high molecular weight ethylene based polymer with time is illustrated in FIG. 1.

### BACKGROUND

Single site catalysts based on transition metal-Schiff base imine ligand complexes are used as homogenous catalysts for the production of disentangled ultra-high molecular weight polyethylene. Conventionally, the transition metal-Schiff base imine ligand complexes are prepared by the chelation of a Schiff base imine ligand with a transition metal halide. Chelation process involves multiple steps, conventionally uses diethyl ether as the reaction medium (which is hazardous), and/or use of pyrophoric reagents such as n-butyllithium.

Chelation involves two steps. In the first step, the Schiff base imine ligand such as phenoxyimine is deprotonated using a base such as n-butyl lithium (which is the most preferred), lithium diisopropylamide, sodium hydride, and potassium hydride, to obtain lithium or sodium salt of phenoxy imines. The second step involves reaction of the lithium or sodium salt of the phenoxy imine with a transition metal halide to obtain the transition metal-Schiff base imine ligand complex. Chelation steps are associated with various drawbacks such as severe reaction conditions like cooling up to −78° C., using hazardous solvents like diethyl ether, and laborious removal of byproducts from the crude mixture to obtain pure transition metal-Schiff base imine ligand complex. Such severe conditions present a great difficulty in scaling up the transition metal-Schiff base imine ligand complex synthesis process to a commercial level.

In another approach, the complex can be prepared by direct addition of phenoxy imine ligands to the transition metal halide that results in imine protonated metal complexes due to generation of hydrogen chloride during the reaction. In such cases, metalation can be carried out in the presence of an organic base such as triethylamine to prevent imine protonation, or the isolated imine protonated metal complexes so formed can be subjected to deprotonation in a subsequent step by adding triethylamine to obtain the desired product. Yet another approach involves the use of a [TiCl₄(THF)₂] adduct at −78° C. to obtain the metal complexes. However, these processes provide a catalyst with low catalytic productivity.

Therefore, there is felt a need to provide a process to prepare the transition metal-Schiff base imine ligand complex using a simple process, and less hazardous reagents.

Objects

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide a simple process to prepare a transition metal-Schiff base imine ligand complex.

Other objects and advantages of the present disclosure will be more apparent from the following description, which is not intended to limit the scope of the present disclosure.

### SUMMARY

The present disclosure relates to a process for preparing a transition metal-Schiff base imine ligand complex. The process comprises the following steps.
(a) An aromatic diamine of Formula-I is reacted with a substituted salicylaldehyde of Formula-IIa, and a substituted salicylaldehyde of Formula-IIb in the presence of an acid catalyst in a first fluid medium at a temperature in the range of 20° C. to 150° C., while stirring to obtain a first product mixture.

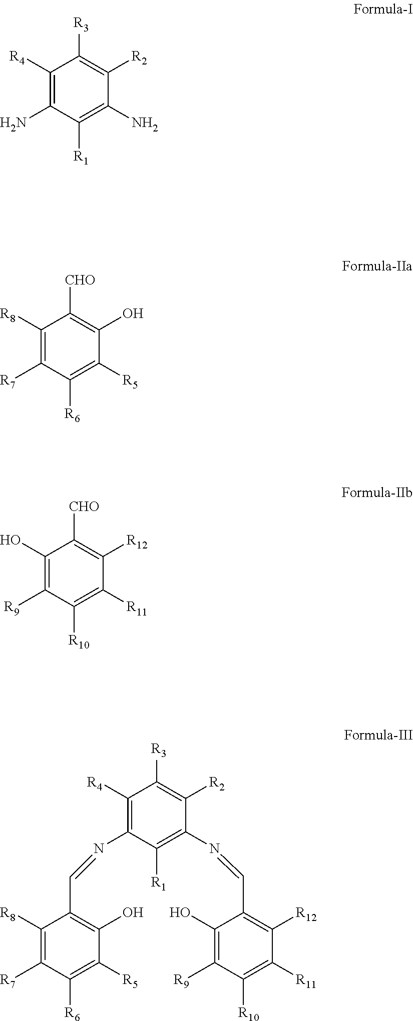

wherein, each of R₁, R₂, R₄, R₆, R₈, R₁₀, and R₁₂ are independently selected from the group consisting of hydrogen, aryl, heteroaryl, and halogen;
R₅, and R₉ are independently selected from tertiary alkyl groups;
R₇, and R₁₁ are independently selected from the group consisting of hydrogen, and tertiary alkyl group; and
R₃ is selected from the group consisting of hydrogen, halogen, alkoxy, aryloxy, carboxyl, and sulphonic acid;
(b) The first product mixture is concentrated under reduced pressure to obtain a first residue comprising a crude Schiff base imine ligand, followed by purification of the first residue to obtain the Schiff base imine ligand, represented by Formula-III.
(c) The Schiff base imine ligand of Formula-III is mixed with a halogenated fluid medium while stirring to obtain a mixture, followed by addition of a transition metal halide to the mixture maintained at a temperature in the range of 20° C. to 40° C., and stirring the resultant mixture to obtain a second product mixture.
(d) The second product mixture is concentrated under reduced pressure to obtain a second residue comprising the crude transition metal-Schiff base imine ligand complex, followed by purification of the second residue using an organic fluid medium to obtain the transition metal-Schiff base imine ligand complex, represented by Formula-IV.

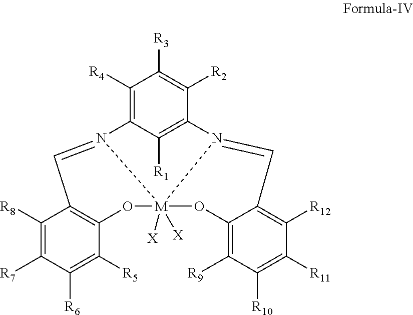

wherein, each of R₁, R₂, R₄, R₆, R₈, R₁₀ and R₁₂ are independently selected from the group consisting of hydrogen, aryl, heteroaryl, and halogen;
R₅, and R₉ are independently selected from tertiary alkyl groups;
R₇, and R₁₁ are independently selected from the group consisting of hydrogen, and tertiary alkyl group;
R₃ is selected from the group consisting of hydrogen, halogen, alkoxy, aryloxy, carboxyl, and sulphonic acid;
M is a transition metal selected from the group consisting of Hafnium (Hf), Manganese (Mn), Iron (Fe), Rhenium (Re), Tungsten (W), Niobium (Nb), Tantalum (Ta), Vanadium (V), and Titanium (Ti); and
X is a halide selected from the group consisting of Cl, Br, and I.

The aromatic diamine is meta-phenylenediamine. The substituted salicylaldehyde of Formula-IIa and the substituted salicylaldehyde of Formula-IIb are independently selected from the group consisting of 3-tert-butylsalicylaldehyde, and 3,5-di-tert-butylsalicylaldehyde. The substituted salicylaldehyde of Formula-IIa and the substituted salicylaldehyde of Formula-IIb can be same or different.

The acid catalyst is at least one selected from the group consisting of para-toluene sulfonic acid, and sulfuric acid. The first fluid medium is at least one selected from the group consisting of toluene, methanol, ethanol, and xylene.

The halogenated fluid medium is at least one selected from the group consisting of dichloromethane, dichloroethane, carbon tetrachloride, and chloroform.

The transition metal halide is at least one selected from the group consisting of Hafnium (Hf) halide, Manganese (Mn) halide, Iron (Fe) halide, Rhenium (Re) halide, Tungsten (W) halide, Niobium (Nb) halide, Tantalum (Ta) halide, Vanadium (V) halide and Titanium (Ti) halide; and the halide is selected from the group consisting of chloride, bromide, and iodide.

The organic fluid medium is at least one selected from the group consisting of n-pentane, n-hexane, n-heptane, n-octane, and n-nonane.

Step (a) is carried out for a time period in the range of 1 hour to 24 hours, and the stirring of resultant mixture in step (C) is carried out for a time period in the range of 1 hour to 48 hours.

The transition metal-Schiff base imine ligand complex can consist of any one of the combinations of the substituents selected from:
(i) R₁, R₂, R₃, R₄, R₆, R₇, R₈, R₁₀, R₁₁, and R₁₂ being hydrogen; R₅, and R₉ being tertiary butyl groups; M is Titanium (Ti); and X is Cl; and
(ii) R₁, R₂, R₃, R₄, R₆, R₈, R₁₀, and R₁₂ being hydrogen; R₅, R₇, R₉, and R₁₁ being tertiary butyl groups; M is Titanium (Ti); and X is Cl.

The molar ratio of the aromatic diamine to the substituted salicylaldehyde of Formula-IIa is 1:1, and the molar ratio of the aromatic diamine to the substituted salicylaldehyde of Formula-IIb is 1:1.

The molar ratio of the Schiff base imine ligand of Formula-III to the transition metal halide is 1:1.

The transition metal-Schiff base imine ligand complex is used to produce disentangled ultra-high molecular weight polyethylene having bulk density in the range of 0.03 g/cc to 0.2 g/cc; crystallinity in the range of 90% to 99%; fibrous and porous morphology; heat (ΔH) of melting in the range of 180 J/g to 245 J/g; stretchability on softening; and molecular weight in the range of 0.1 to 12 million g/mole.

### BRIEF DESCRIPTION OF ACCOMPANYING DRAWINGS

FIG. 1 illustrates the change in the elastic modulus of the DUHMWPE based polymer with time when tested by strain controlled rheometer using 8 mm parallel plate geometry.

FIGS. 2A, 3A, and 4A illustrate total ion chromatograms of catalyst 1, catalyst 2 and catalyst 3 respectively, as described in Table-1;

FIGS. 2B, 3B, and 4B illustrate mass spectra of catalyst 1, catalyst 2 and catalyst 3 respectively, as described in Table-1;

FIGS. 2C, 3C, and 4C illustrate expanded mass spectra of catalyst 1, catalyst 2 and catalyst 3 respectively, as described in Table-1;

FIG. 5 illustrates an XRD pattern of a disentangled ultra-high molecular weight polyethylene (DUHMWPE-1) obtained using the complex of the present disclosure as the catalyst 1.

FIG. 6 illustrates a DSC thermograph of the DUHMWPE-1 obtained using the complex of the present disclosure as the catalyst 1.

FIG. 7 illustrates a SEM image of the DUHMWPE-1 obtained using the complex of the present disclosure as the catalyst 1.

FIG. 8 illustrates a SEM image of the DUHMWPE-2 obtained using the complex of the present disclosure as the catalyst 2.

FIG. 9 illustrates a SEM image of the DUHMWPE-3 obtained using the complex of the present disclosure as the catalyst 3.

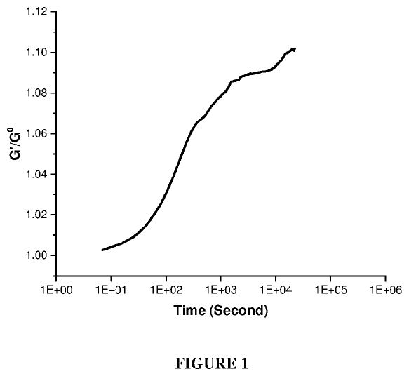

### DETAILED DESCRIPTION

Conventional processes for preparing the transition metal-Schiff base imine ligand complex are associated with disadvantages such as use of severe reaction conditions, use of hazardous reaction medium, use of pyrophoric reagents, and tedious purification procedures. Further, the conventional processes are difficult to scale up.

The present disclosure envisages a simple process to synthesize the catalyst by direct chelation of the Schiff base imine ligand using a transition metal halide. The process of the present disclosure can be easily scaled up to commercial scale.

In accordance with an aspect of the present disclosure there is provided a process for preparing a transition metal-Schiff base imine ligand complex. The process comprises following steps.
(a) An aromatic diamine of Formula-I is reacted with a substituted salicylaldehyde of Formula-IIa, and a substituted salicylaldehyde of Formula-IIb in the presence of an acid catalyst in a first fluid medium at a temperature in the range of 20° C. to 150° C., while stirring to obtain a first product mixture,

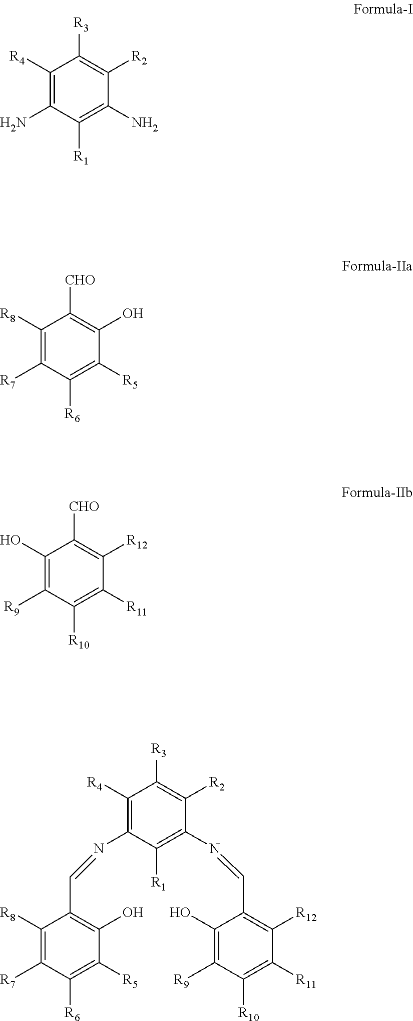

wherein, each of R₁, R₂, R₄, R₆, R₈, R₁₀, and R₁₂ are independently selected from the group consisting of hydrogen, aryl, heteroaryl, and halogen;
R₅, and R₉ are independently selected from tertiary alkyl groups;
R₇, and R₁₁ are independently selected from the group consisting of hydrogen, and tertiary alkyl group; and
R₃ is selected from the group consisting of hydrogen, halogen, alkoxy, aryloxy, carboxyl, and sulphonic acid.
(b) The first product mixture is concentrated under reduced pressure to obtain a first residue comprising a crude Schiff base imine ligand, followed by purification of the first residue to obtain the Schiff base imine ligand, represented by of Formula-III.
(c) The Schiff base imine ligand of Formula-III is mixed with a halogenated fluid medium, while stirring, to obtain a mixture, followed by addition of a transition metal halide to the mixture maintained at a temperature in the range of 20° C. to 40° C., and stirring the resultant mixture to obtain a second product mixture.
(d) The second product mixture is concentrated under reduced pressure to obtain a second residue comprising the crude transition metal-Schiff base imine ligand complex, followed by purification of the second residue using an organic fluid medium to obtain the transition metal-Schiff base imine ligand complex, represented by Formula-IV.

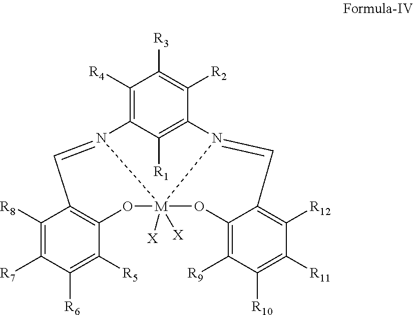

wherein, each of R₁, R₂, R₄, R₆, R₈, R₁₀, and R₁₂ are independently selected from the group consisting of hydrogen, aryl, heteroaryl, and halogen;
R₅, and R₉ are independently tertiary alkyl groups;
R₇, and R₁₁ are independently selected from the group consisting of hydrogen, and tertiary alkyl group;
R₃ is selected from the group consisting of hydrogen, halogen, alkoxy, aryloxy, carboxyl, and sulphonic acid;
M is a transition metal selected from the group consisting of Hafnium (Hf), Manganese (Mn), Iron (Fe), Rhenium (Re), Tungsten (W), Niobium (Nb), Tantalum (Ta), Vanadium (V), and Titanium (Ti); and
X is a halide selected from the group consisting of Cl, Br, and I.

In accordance with an embodiment of the present disclosure, the aromatic diamine is meta-phenylenediamine.

In accordance with an embodiment of the present disclosure, the substituted salicylaldehyde of Formula-IIa, and the substituted salicylaldehyde of Formula-IIb are independently selected from the group consisting of 3-tert-butylsalicylaldehyde, and 3,5-di-tert-butylsalicylaldehyde.

The substituted salicylaldehyde of Formula-IIa and the substituted salicylaldehyde of Formula-IIb can be same or different.

In accordance with an exemplary embodiment of the present disclosure, the substituted salicylaldehyde of Formula-IIa, and the substituted salicylaldehyde of Formula-IIb is 3-tert-butylsalicylaldehyde.

The acid catalyst is at least one selected from the group consisting of para-toluene sulfonic acid, and sulfuric acid. The acid catalyst accelerates the Schiff base formation as well as leads to complete product formation.

Certain Schiff base formation reaction takes place at a lower temperature such as 20° C., whereas some other Schiff base formation reactions require higher temperature such as 150° C.

The first fluid medium is at least one selected from the group consisting of toluene, methanol, ethanol, and xylene.

The halogenated fluid medium is at least one selected from the group consisting of dichloromethane, dichloroethane, carbon tetrachloride, and chloroform.

In accordance with one embodiment of the present disclosure, the halogenated fluid medium is dichloromethane.

In accordance with an embodiment of the present disclosure, the transition metal halide is at least one selected from the group consisting of Hafnium (Hf) halide, Manganese (Mn) halide, Iron (Fe) halide, Rhenium (Re) halide, Tungsten (W) halide, Niobium (Nb) halide, Tantalum (Ta) halide, Vanadium (V) halide, and Titanium (Ti) halide. The halide is selected from the group consisting of chloride, bromide, and iodide.

In accordance with one embodiment of the present disclosure, the transition metal halide is Titanium tetrachloride.

The organic fluid medium is at least one selected from the group consisting of n-pentane, n-hexane, n-heptane, n-octane, and n-nonane.

In accordance with one embodiment of the present disclosure, the organic fluid medium is n-hexane.

The reaction medium and the reaction temperature play a crucial role in direct chelation of the Schiff base imine ligand with transition metal halide.

In accordance with an embodiment of the present disclosure, step (a) is carried out for a time period in the range of 1 hour to 24 hours, and the stirring of resultant mixture in step (C) is carried out for a time period in the range of 1 hour to 48 hours.

The transition metal-Schiff base imine ligand complex can consist of any one of the combinations of the substituents selected from:
i. R₁, R₂, R₃, R₄, R₆, R₇, R₈, R₁₀, R₁₁, and R₁₂ being hydrogen; R₅, and R₉ being tertiary butyl groups; M is Titanium (Ti); and X is Cl; and
ii. R₁, R₂, R₃, R₄, R₆, R₈, R₁₀, and R₁₂ being hydrogen; R₅, R₇, R₉, and R₁₁ being tertiary butyl groups; M is Titanium (Ti); and X is Cl.

In accordance with an embodiment of the present disclosure, the molar ratio of the aromatic diamine to the substituted salicylaldehyde of Formula-IIa is 1:1, and the molar ratio of the aromatic diamine to the substituted salicylaldehyde of Formula-IIb is 1:1.

The molar ratio of the Schiff base imine ligand of Formula-III to the transition metal halide is 1:1.

The chelation process of the present disclosure is carried out at an ambient temperature, ranging from 20° C. to 40° C. Hence, the process of the present disclosure is easy to scale up at industrial scale as compared to the processes that are carried out at low temperature such as −78° C. The chelation step of the process of present disclosure is carried out using less hazardous reagents. Further, the chelation step of the process of present disclosure employs mild reaction conditions. In contrast to conventional processes, the chelation process of the present disclosure does not use pyrophoric reagents such as n-butyl lithium, lithium diisopropylamide and the like. Therefore, the process of the present disclosure is simple, economical, and less hazardous.

The catalytic activity of the transition metal-Schiff base imine ligand complex of the present disclosure is evaluated by a series of ethylene polymerization experiments using polymethylaluminoxane (PMAO) and/or methylaluminoxane (MAO) as co-catalyst. The ethylene polymerization is performed at ethylene pressure in the range of 0.1 bar to 20 bar and at a temperature of 0° C. to 60° C. for 1 hour to 10 hours to obtain dis-entangled ultra-high molecular weight polyethylene (DUHMWPE). The DUHMWPE obtained is characterized by at least one of the following properties:
(i) low bulk density (0.03 g/cc to 0.2 g/cc);
(ii) high crystallinity (90% to 99%);
(iii) fibrous and porous morphology;
(iv) high heat (ΔH) of melting (180 J/g to 245 J/g);
(v) stretchability on softening; and
(vi) molecular weight in the range of 0.1 to 12 million g/mole.

It is observed that, DUHMWPE obtained by the process of the present disclosure is identical, with respect to the above mentioned characteristics, with DUHMWPE obtained by the conventional process.

The present disclosure is further described in light of the following experiments which are set forth for illustration purpose only and not to be construed for limiting the scope of the disclosure. The following laboratory scale experiments can be scaled up to industrial/commercial scale.

### EXPERIMENTS

### Experiment 1: Preparation of Titanium-Schiff Base Imine Ligand Complex (Hereinafter Referred to as Catalyst-1)

Step A: Preparation of Schiff Base Imine Ligand (Formula-IIIA)

All operations were carried out under nitrogen atmosphere. 10.8 g of m-phenylene diamine (100 mmol), 34.2 ml of 3-tert butylsalicylaldehyde (200 mmol) and 50 mg of p-toluene sulfonic acid were dissolved in 250 ml of anhydrous toluene. The mixture was stirred at 110° C. under nitrogen atmosphere for 5 hours to obtain a first product mixture. The first product mixture was concentrated under reduced pressure to obtain a first residue as a dark brown solid. The first residue was purified by column chromatography on silica gel using n-hexane/ethyl acetate (100:1) as eluent to obtain 36 g of Schiff base imine ligand of Formula-IIIA as a bright orange solid (yield=85%).

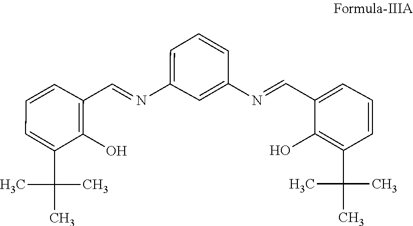 [SMILES: CC(C)(C)c1cccc(/C=N/c2cccc(/N=C/c3cccc(C(C)(C)C)c3O)c2)c1O]

Step B: Direct Chelation of the Schiff Base Imine Ligand (Formula-IVA)

Glasswares were oven dried and cooled under nitrogen flow, and all operations were carried out under nitrogen atmosphere. 1 g of the Schiff base imine ligand (2.33 mmol) obtained from step (A) of Experiment 1 was mixed with 30 ml of dichloromethane under stirring to obtain a mixture. To this mixture, 0.25 ml of titanium tetrachloride (2.32 mmol) was added dropwise at 30° C., followed by stirring for 24 hours to obtain a second product mixture. The second product mixture was concentrated under reduced pressure to obtain a dark brown second residue. The second residue was washed thrice with 20 ml of n-hexane to obtain 1.3 g of brownish red colored Titanium-Schiff base imine ligand complex (yield=97%).

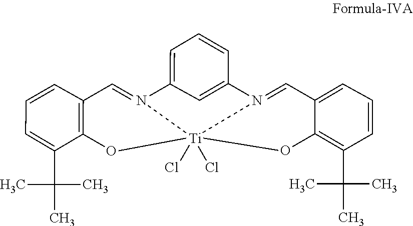

Following the same procedure as given in steps (A) and (B) of experiment 1, the preparation of Titanium-Schiff base imine ligand complex was scaled up to 5 g (hereinafter referred as catalyst 2) and to 10 g (hereinafter referred as catalyst 3).

### Experiment 1a: Preparation of Titanium-Schiff Base Imine Ligand Complex (Hereinafter Referred to as Catalyst-2)

Step B: Direct Chelation of the Schiff Base Imine Ligand (Formula-IVA)

Glasswares were oven dried and cooled under nitrogen flow, and all operations were carried out under nitrogen atmosphere. 5 g of the Schiff base imine ligand (11.65 mmol) obtained from step (A) of Experiment 1 was mixed with 70 ml of dichloromethane under stirring to obtain a mixture. To this mixture, 1.25 ml of titanium tetrachloride (11.6 mmol) was added dropwise at 30° C., followed by stirring for 24 hours to obtain a product mixture. The product mixture was concentrated under reduced pressure to obtain a dark brown residue. The residue was washed thrice with 30 ml of n-hexane to obtain 6.0 g of brownish red colored Titanium-Schiff base imine ligand complex (Yield=94%).

Experiment 1b: Preparation of Titanium-Schiff Base Imine Ligand Complex (Hereinafter Referred to as Catalyst-3)

Step B: Direct Chelation of the Schiff Base Imine Ligand (Formula-IVA)

Glasswares were oven dried and cooled under nitrogen flow, and all operations were carried out under nitrogen atmosphere. 10 g of the Schiff base imine ligand (23.3 mmol) obtained from step (A) of Experiment 1 was mixed with 150 ml of dichloromethane under stirring to obtain a mixture. To this mixture, 2.50 ml of titanium tetrachloride (23.3 mmol) was added dropwise at 30° C., followed by stirring for 24 hours to obtain a product mixture. The product mixture was concentrated under reduced pressure to obtain a dark brown residue. The residue was washed thrice with 40 ml of n-hexane to obtain 11.5 g of brownish red colored Titanium-Schiff base imine ligand complex (Yield=90%).

Catalyst 1, catalyst 2, and catalyst 3 were characterized by mass spectroscopy and elemental analysis.

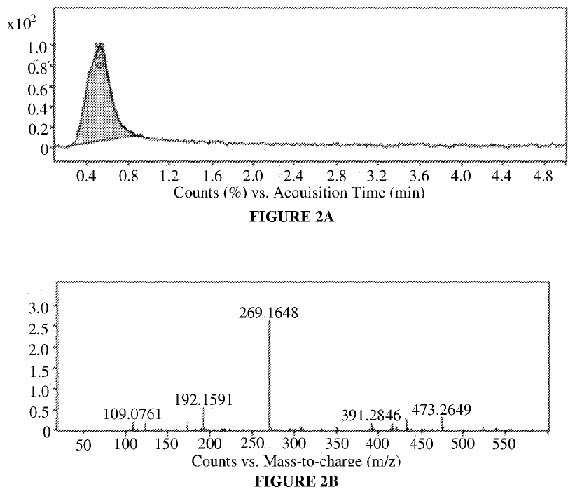

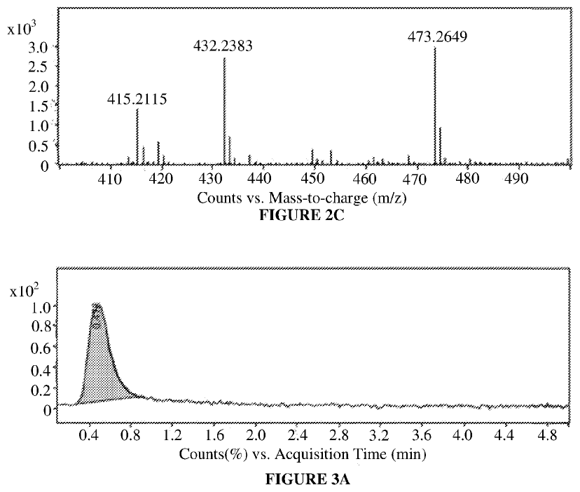

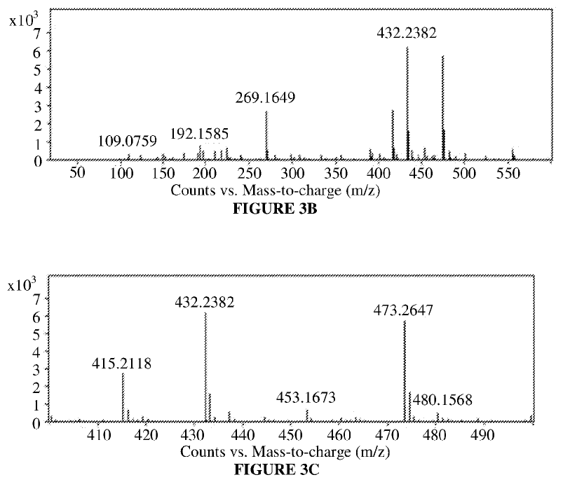

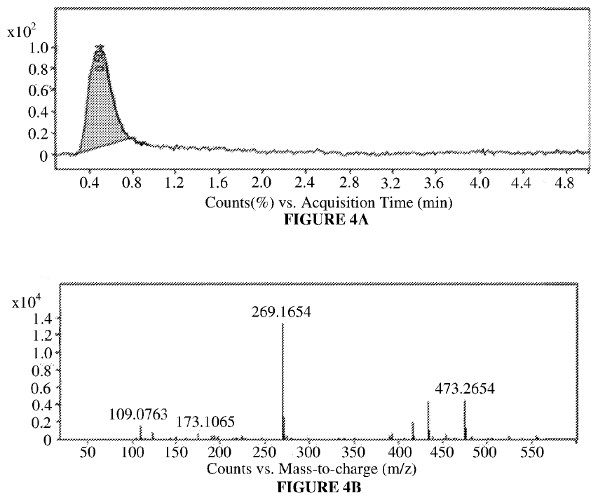

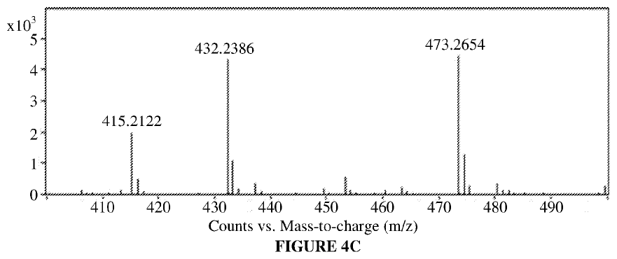

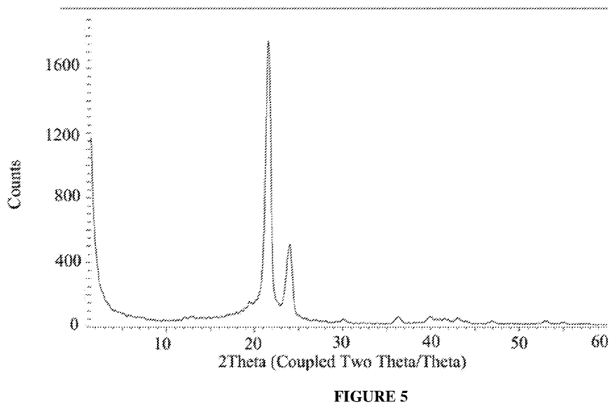

FIGS. 2A, 3A, and 4A illustrate the total ion chromatograms of catalyst 1, catalyst 2 and catalyst 3 respectively. FIGS. 2B, 3B, and 4B illustrate the mass spectra of catalyst 1, catalyst 2 and catalyst 3 respectively. FIGS. 2C, 3C, and 4C illustrate the expanded mass spectra of catalyst 1, catalyst 2, and catalyst 3 respectively.

The structures of catalyst 1, catalyst 2, and catalyst 3 were confirmed by mass spectroscopy, and elemental analysis.

This clearly established the repeatability and reproducibility of the catalyst synthesis process.

### Experiment 2: Evaluation of the Catalytic Activity of the Transition Metal-Schiff Base Imine Ligand Complex

Catalytic activity of the transition metal-Schiff base imine ligand complexes i.e., catalyst 1, catalyst 2, and catalyst 3 were evaluated by ethylene polymerization.

Ethylene polymerization was performed in a glass reactor equipped with a stirrer, a temperature indicator, a pressure indicator, and feeding lines for catalyst, ethylene gas, and nitrogen. The glass reactor was charged with 500 mL of anhydrous hexane followed by addition of 1.6 ml of polymethylaluminoxane. 9 mg of titanium-Schiff base imine ligand complex (catalyst-1) was added in the reactor to form active catalyst composition. Ethylene gas was charged in the reactor till a pressure of 6 bar was reached. The polymerization was carried out at 6 bar ethylene pressure, at 50° C. and at a speed of 1200 rpm for 3 hours. The reactor was depressurized and cooled to 30° C. The slurry was filtered and polymer was dried under reduced pressure at 70° C. for 3 hours to obtain dis-entangled ultra-high molecular weight polyethylene (DUHMWPE-1).

DUHMWPE-2 and DUHMWPE-3 were prepared by a process similar to experiment 2, using catalyst 2, and catalyst 3, respectively, instead of catalyst 1.

### Experiment 3: Preparation of Titanium-Schiff Base Imine Ligand Complex (Hereinafter Referred to as Comparative Catalyst)

For comparison, a Titanium-Schiff base imine ligand complex was prepared by the process as mentioned below (hereinafter referred to as the comparative catalyst). The catalytic activity of the comparative catalyst was also evaluated in the same manner as the catalyst of the present disclosure.

Step B: Lithiation of Schiff Base Imine Ligand Followed by Chelation with Titanium Tetrachloride

Glasswares were oven dried and cooled under nitrogen flow, and all operations were carried out under nitrogen atmosphere. 1.0 g of Schiff base imine ligand (2.33 mmol) obtained from step (A) of Experiment 1 was dissolved in 100 mL of dry diethyl ether under gentle agitation to obtain a first mixture. The first mixture was cooled to −78° C. using a dry ice, acetone bath to obtain a cooled first mixture. To the cooled first mixture, 3.20 mL of n-butyllithium/n-hexane solution (1.52 M, 4.94 mmol) was added dropwise over a period of 10 minutes to 15 minutes to obtain a second mixture. The second mixture was allowed to warm to room temperature and was stirred for 3 hours to complete the lithiation reaction to obtain a third mixture. The third mixture was again cooled to −78° C. and 0.25 mL of titanium chloride (2.32 mmol) was added to it dropwise to obtain fourth mixture. The fourth mixture was allowed to warm to room temperature and was stirred for 15 hours to 18 hours to obtain a dark red brown mixture. The dark red brown mixture was concentrated under reduced pressure to obtain dark brown solid. 50 mL of dichloromethane was added to the dark brown solid and stirred for 5 minutes, and then filtered through a medium porosity G-2 sinter funnel. The filtration step was repeated twice using 50 mL of dichloromethane to remove all solid impurities from dark brown solid to obtain a filtrate. The filtrate was combined and dried under reduced pressure to obtain brown solids. The brown solids were then washed three times with 20 mL of n-hexane/diethyl ether (95:5) solution, followed by washing with n-hexane to obtain titanium-Schiff base imine ligand complex (Formula-IVA).

The ethylene polymer obtained using catalyst 1, catalyst 2, and catalyst 3 is referred to as DUHMWPE-1, DUHMWPE-2, and DUHMWPE-3 respectively, whereas the ethylene polymer obtained by using the comparative catalyst is referred to as DUHMWPE-4.

Table-1 summarizes the performance of the transition metal-Schiff base imine ligand complexes of the present disclosure and that of the comparative catalyst for ethylene polymerization.

TABLE 1
Performance of the catalyst obtained in experiment 1 for ethylene polymerization

| | | Pressure | Polymerization | | | Molecular | Bulk |
|---|---|---|---|---|---|---|---|
| Experiment. | | (P) | temperature | Time | | Weight | Density |
| No. | Catalyst (mg) | (bar) | (° C.) | (hours) | DUHMWPE (g) | (M) | (g/cc |
| 1 | (Catalyst-1) 9.0 | 6.0 | 50 | 3 | 109 (DUHMWPE-1) | 4.2 | 0.104 |
| 2 | (Catalyst-2) 9.0 | 6.0 | 50 | 3 | 110 (DUHMWPE-2) | 4.3 | 0.107 |
| 3 | (Catalyst-3) 9.0 | 6.0 | 50 | 3 | 101 (DUHMWPE-3) | 4.1 | 0.085 |
| 4 | (Comparative | 6.0 | 50 | 3 | 110 (DUHMWPE-4) | 4.2 | 0.10 |
| | catalyst) 9.0 | | | | | | |

Polymerization conditions: 0.5 L dry and pure hexane, Polymethylaluminoxane: 1.6 ml, rpm: 1200

It is evident from Table-1 that, the molecular weight and the bulk density of the DUHMWPE obtained by the catalyst of the present disclosure were similar to that obtained by the comparative catalyst.

Further, the amount of DUHMWPE produced by the catalyst of the present disclosure is in the range of 101 to 110 grams per 9 milligrams of the catalyst. This data indicates that, the catalyst productivity of the present disclosure is high.

DUHMWPE prepared by experiments 1 to 3 were characterized by different analytical techniques such as X-ray diffraction (XRD), differential scanning calorimetry (DSC), and scanning electron microscope (SEM). The data is provided in Table-2.

TABLE 2
Properties of DUHMWPE-1, DUHMWPE-2, and DUHMWPE-3

| Properties | DUHMWPE-1 | | DUHMWPE-2 | | DUHMWPE-3 | |
|---|---|---|---|---|---|---|
| Crystallinity | 92.4% | | 90.3% | | 93.1% | |
| Morphology | Fibrous and | | Fibrous and | | Fibrous and | |
| | porous | | porous | | porous | |
| Heat (ΔH) of melting | 203.4 | J/g | 194.3 | J/g | 207.7 | J/g |
| Melting temperature | 140.14° | C. | 142.55° | C. | 140.89° | C. |

| | | | |
|---|---|---|---|
| Stretchability on | Yes | Yes | Yes |
| softning | | | |

It is evident from Table-2 that the Titanium-Schiff base imine ligand complex of the present disclosure exhibit excellent catalytic activity to polymerize ethylene and provides disentangled ultra-high molecular weight polyethylene (DUHMWPE) having high crystallinity, fibrous and porous morphology, high heat of melting, and stretchability on softening.

XRD Analysis (to Determine the Crystallinity of the Resulting Polymer Samples)

X-ray diffraction analysis of DUHMPWE-1 was carried out using CuKa (k=1.542 Å) radiation using an X-ray diffractometer operating at 40 kV and 20 mA. DUHMWPE-1 (obtained by catalyst 1) showed two distinct peaks at 2θ of 21° and 24°, which correspond to the orthorhombic (110) and (200) planes respectively. The XRD spectrum did not show peak at 20=19.8° which corresponds to the amorphous state. The XRD analysis of DUHMPWE-1 indicates high degree of crystallinity in DUHMPWE-1. The XRD pattern of DUHMWPE-1 is depicted in FIG. 5.

DSC Analysis (to Determine the Melting Point and ΔH of Melting of Polymer Samples)

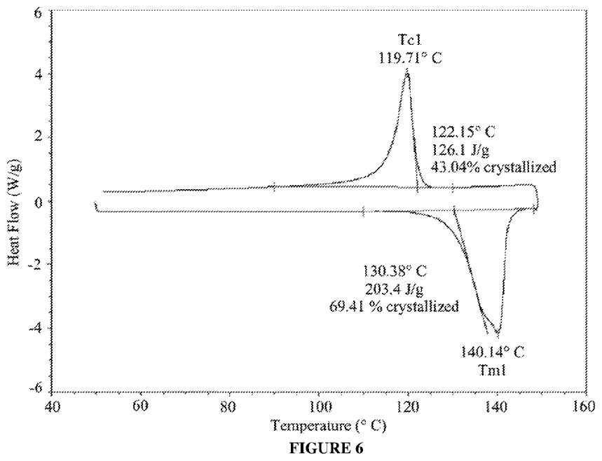

DSC of DUHMWPE-1 (obtained using Catalyst 1) was carried out in the following manner DUHMWPE-1 was heated under nitrogen atmosphere from 20° C. to 180° C. at a rate of 10° C./min, equilibrated for 3 min, and was subsequently cooled down to 20° C. After keeping the temperature constant at 20° C. for 3 min, the sample was again heated to 180° C. at a rate of 10° C./min. It was observed from DSC analysis (FIG. 6), that DUHMWPE-1 melts at 140.14° C. and the heat of melting is 203.4 J/g.

SEM (Scanning Electron Microscopy) of the DUHMWPE-1

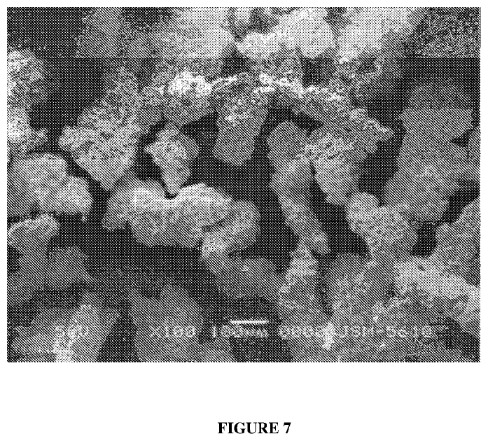

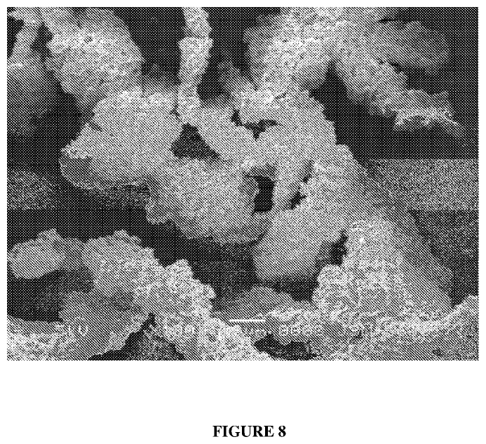

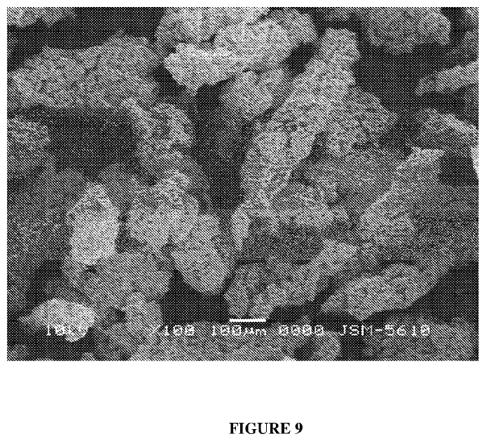

FIGS. 7, 8, and 9 illustrates an SEM image which depicts fibrous and porous morphology of the DUHMWPE-1, DUHMWPE-2, and DUHMWPE-3 respectively. Because of porous nature, the bulk density of DUHMWPE-1, DUHMWPE-2, and DUHMWPE-3 is in the range of −0.03-0.2 g/cc as compared to the bulk density of −0.4 g/cc for normal UHMWPE.

DUHMWPE-1, DUHMWPE-2, and DUHMWPE-3 obtained by the process of the present disclosure were identical in all aspects of DUHMWPE-4 obtained by the process of the prior art.

Technical Advances and Economical Significance

The process of the present disclosure described herein above has several technical advantages including, but not limited to, the realization of:
a simple process for preparing a transition metal-Schiff base imine ligand complex;
a process for preparing a transition metal-Schiff base imine ligand complex that employs less hazardous reagents, and mild reaction conditions; and
a process for preparing DUHMWPE using transition metal-Schiff base imine ligand complex.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A process for preparing a transition metal-Schiff base imine ligand complex, the process comprising:
(a) reacting an aromatic diamine of Formula-I, with a substituted salicylaldehyde of Formula-IIa, and a substituted salicylaldehyde of Formula-IIb in the presence of an acid catalyst in a first fluid medium at a temperature in the range of 20° C. to 150° C., while stirring to obtain a first product mixture; 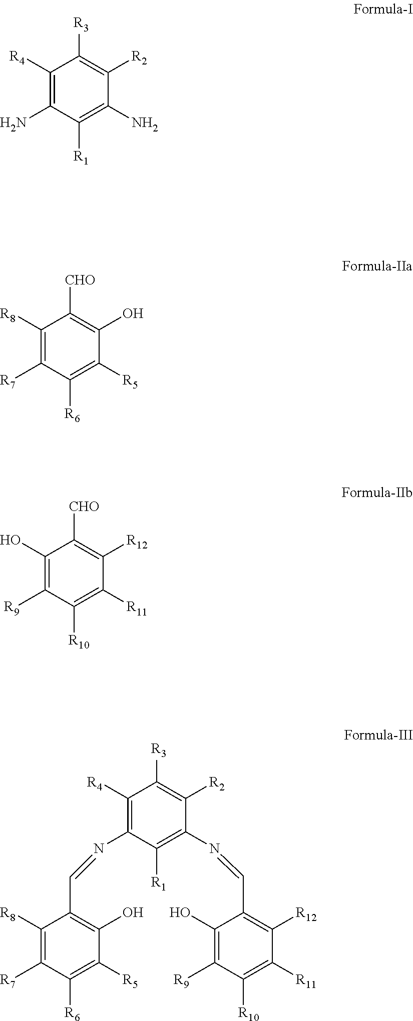
wherein, each of R₁, R₂, R₄, R₆, R₈, R₁₀, and R₁₂ are independently selected from the group consisting of hydrogen, aryl, heteroaryl, and halogen;
R₅, and R₉ are independently selected from tertiary alkyl groups;
R₇, and R₁₁ are independently selected from the group consisting of hydrogen, and tertiary alkyl group; and
R₃ is selected from the group consisting of hydrogen, halogen, alkoxy, aryloxy, carboxyl, and sulphonic acid;
(b) concentrating the first product mixture under reduced pressure to obtain a first residue comprising crude Schiff base imine ligand, followed by purification of the first residue to obtain a Schiff base imine ligand, represented by Formula-III;
(c) mixing the Schiff base imine ligand of Formula-III and a halogenated fluid medium while stirring to obtain a mixture, followed by addition of a transition metal halide to the mixture maintained at a temperature in the range of 20° C. to 40° C., and stirring the resultant mixture to obtain a second product mixture; and
(d) concentrating the second product mixture under reduced pressure to obtain a second residue comprising crude transition metal-Schiff base imine ligand complex, followed by purification of the second residue using an organic fluid medium to obtain the transition metal-Schiff base imine ligand complex, represented by Formula-IV. 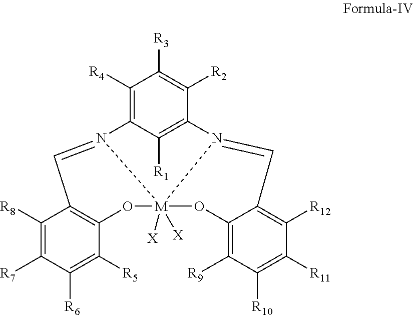
wherein, each of R₁, R₂, R₄, R₆, R₈, R₁₀, and R₁₂ are independently selected from the group consisting of hydrogen, aryl, heteroaryl, and halogen;
R₅, and R₉ are independently selected from tertiary alkyl groups;
R₇, and R₁₁ are independently selected from the group consisting of hydrogen, and tertiary alkyl group;
R₃ is selected from the group consisting of hydrogen, halogen, alkoxy, aryloxy, carboxyl, and sulphonic acid;
M is a transition metal selected from the group consisting of Hafnium (Hf), Manganese (Mn), Iron (Fe), Rhenium (Re), Tungsten (W), Niobium (Nb), Tantalum (Ta), Vanadium (V), and Titanium (Ti); and
X is a halide selected from the group consisting of Cl, Br, and I.

2. The process of claim 1, wherein the aromatic diamine is meta-phenylenediamine.

3. The process of claim 1, wherein the substituted salicylaldehyde of Formula-IIa and the substituted salicylaldehyde of Formula-IIb are independently selected from the group consisting of 3-tert-butylsalicylaldehyde, and 3,5-di-tert-butylsalicylaldehyde.

4. The process of claim 1, wherein the substituted salicylaldehyde of Formula-IIa and the substituted salicylaldehyde of Formula-IIb are the same or different.

5. The process of claim 1, wherein the acid catalyst is at least one selected from the group consisting of para-toluene sulfonic acid, and sulfuric acid.

6. The process of claim 1, wherein the first fluid medium is at least one selected from the group consisting of toluene, methanol, ethanol, and xylene.

7. The process of claim 1, wherein the halogenated fluid medium is at least one selected from the group consisting of dichloromethane, dichloroethane, carbon tetrachloride, and chloroform.

8. The process of claim 1, wherein the transition metal halide is at least one selected from the group consisting of Hafnium (Hf) halide, Manganese (Mn) halide, Iron (Fe) halide, Rhenium (Re) halide, Tungsten (W) halide, Niobium (Nb) halide, Tantalum (Ta) halide, Vanadium (V) halide, and Titanium (Ti) halide; and the halide is selected from the group consisting of chloride, bromide, and iodide.

9. The process of claim 1, wherein the organic fluid medium is at least one selected from the group consisting of n-pentane, n-hexane, n-heptane, n-octane, and n-nonane.

10. The process of claim 1, wherein step (a) is carried out for a time period in the range of 1 hour to 24 hours, and the stirring of the resultant mixture in step (C) is carried out for a time period in the range of 1 hour to 48 hours.

11. The process of claim 1, wherein the transition metal-Schiff base imine ligand complex consists any one of the combinations of substituents selected from:
i. R₁, R₂, R₃, R₄, R₆, R₇, R₈, R₁₀, R₁₁, and R₁₂ being hydrogen; R₅, and R₉ being tertiary butyl groups; M is Titanium (Ti); and X is Cl; and
ii. R₁, R₂, R₃, R₄, R₆, R₈, R₁₀, and R₁₂ being hydrogen; R₅, R₇, R₉, and R₁₁ being tertiary butyl groups; M is Titanium (Ti); and X is Cl.

12. The process of claim 1, wherein the molar ratio of the aromatic diamine to the substituted salicylaldehyde of Formula-IIa is 1:1, and the molar ratio of the aromatic diamine to the substituted salicylaldehyde of Formula-IIb is 1:1.

13. The process of claim 1, wherein the molar ratio of the Schiff base imine ligand of Formula-III to the transition metal halide is 1:1.

14. A transition metal-Schiff base imine ligand complex prepared by the process of claim 1.

15. (canceled)

16. A method of producing a disentangled ultra-high molecular weight polyethylene, wherein the method comprises:
performing an ethylene polymerization reaction in the presence of the transition metal-Schiff base imine ligand complex prepared according to the process of claim 1, wherein the ethylene polymerization is performed at an ethylene pressure in the range of 0.1 bar to 20 bar and at a temperature of 0° C. to 60° C. for 1 hour to 10 hours to obtain a disentangled ultra-high molecular weight polyethylene,
wherein the disentangled ultra-high molecular weight polyethylene has the following properties:
bulk density in the range of 0.03 g/cc to 0.2 g/cc;
crystallinity in the range of 90% to 99%;
fibrous and porous morphology;
heat (ΔH) of melting in the range of 180 J/g to 245 J/g;
stretchability on softening; and
molecular weight in the range of 0.1 to 12 million g/mole.
